(19) United States
(12) Patent Application Publication
(10) Pub. No.: US 2025/0388251 A1
(43) Pub. Date: Dec. 25, 2025

(54) HANDLING TRUCK

(71) Applicants: INTRADIN (HUZHOU) INTELLIGENT TECHNOLOGY CO., LTD., Huzhou (CN); INTRADIN (HUZHOU) PRECISION TECHNOLOGY CO.,LTD., Huzhou (CN)

(72) Inventors: Junliang WANG, Huzhou (CN); Liang ZHOU, Huzhou (CN)

(21) Appl. No.: 19/317,624

(22) Filed: Sep. 3, 2025

(30) Foreign Application Priority Data
Mar. 26, 2025 (CN) 202520553121.2
Jun. 11, 2025 (CN) 202521189444.4

(51) Int. Cl. B62B 3/02; B62B 3/06; B62B 5/06

(52) U.S. Cl. CPC B62B 3/02; B62B 3/0618; B62B 3/0643; B62B 5/063; B62B 2205/006; B62B 2205/30

(57) ABSTRACT

A handling truck comprises a mast assembly, a base, a moving assembly, and a connecting member. The base is fixedly disposed at the bottom end of the mast assembly, and the base is provided with a socket portion. The moving assembly includes a leg assembly and a connecting portion, wherein one end of the connecting portion is connected to the leg assembly, and the other end of the connecting portion is configured for socket engagement with the socket portion. The moving assembly is configured to drive the mast assembly to move on a plane. The connecting member is configured to pass through the socket portion and the connecting portion to achieve a detachable connection between the moving assembly and the base. The present application provides a handling truck capable of reducing packaging costs and transportation costs.

### CROSS REFERENCE TO RELATED APPLICATIONS

This application is based upon and claims priority to Chinese Patent Application No. 202521189444.4, filed on Jun. 11, 2025 and to Chinese Patent Application No. 202520553121.2, filed on Mar. 26, 2025, the entire content of which is incorporated herein by reference.

### TECHNICAL FIELD

The present disclosure relates to the technical field of material handling, and particularly to a handling truck.

### BACKGROUND

Handling trucks are typically used for moving heavy objects that are difficult for individuals to move. In existing handling trucks, the moving assembly is fixedly connected to the base, while the base and the mast assembly are in detachably fixed connection. During transportation of the handling truck, the base and the mast assembly are disassembled for packaging. However, since the moving assembly and the base are non-detachably connected, they form a relatively large three-dimensional configuration, occupying substantial space, which makes transportation inconvenient and increases packaging costs as well as transportation costs.

### SUMMARY

In view of the above, it is necessary to provide a handling truck capable of reducing packaging costs and transportation costs.

A handling truck, wherein the handling truck comprises:
a mast assembly;
a base, fixedly disposed at a bottom end of the mast assembly, wherein the base is provided with a socket portion;
a moving assembly, wherein the moving assembly comprises a leg assembly and a connecting portion, a first end of the connecting portion is connected to the leg assembly, a second end of the connecting portion is configured for socket engagement with the socket portion, and the moving assembly is configured to drive the mast assembly to move on a plane; and
a connecting member, wherein the connecting member is configured to pass through the socket portion and the connecting portion to achieve a detachable connection between the moving assembly and the base.

Optionally, the handling truck further comprises a load-bearing device, wherein the load-bearing device is detachably disposed on a side surface of the mast assembly, the load-bearing device is configured to carry objects, and the load-bearing device is movable along an axial direction of the mast assembly.

Optionally, the mast assembly comprises a fixed member, a sliding member, and a driving member, wherein the base is disposed at a bottom of the fixed member, an interior of the fixed member is provided with a main channel, the fixed member is provided with a first opening, the main channel communicates with the first opening, the sliding member is disposed in the main channel, the sliding member has a first side wall, the first side wall is disposed facing the first opening, the load-bearing device is detachably disposed on the first side wall, the driving member is disposed inside the sliding member with a top of the driving member connected to a top of the sliding member, and the driving member is capable of extending and retracting along its own axial direction to thereby drive the sliding member and the load-bearing device to move along the main channel.

Optionally, the first side wall is provided with a plurality of interfaces, wherein the plurality of interfaces are spaced apart and spread along a height direction of the first side wall, the load-bearing device comprises an insertion portion, and the insertion portion is configured to be inserted into the interfaces to achieve a detachable connection between the load-bearing device and the sliding member.

Optionally, the mast assembly further comprises a handle, wherein the handle is disposed on a side wall of the fixed member distal to the first opening.

Optionally, the fixed member comprises a main body portion and two flange portions, wherein the two flange portions are respectively disposed on two sides of the main body portion, each of the two flange portions defines an auxiliary channel, a part of the main channel is located inside the main body portion, another part of the main channel communicates with the auxiliary channels, and the auxiliary channels extend along a length direction of the main channel.

Optionally, the mast assembly further comprises at least two bearings, wherein the two bearings are respectively disposed on two opposite side walls of the sliding member, and each of the bearings is disposed in a corresponding one of the auxiliary channels to thereby attach the sliding member to the fixed member.

Optionally, the mast assembly further comprises a buffer member, wherein the buffer member covers an outer ring of each bearing.

Optionally, the driving member is a foot-operated hydraulic cylinder, wherein the driving member comprises a housing composed of a base seat and an outer cylinder barrel, a valve body is fixedly installed inside the housing, an inner cylinder barrel located inside the outer cylinder barrel is fixedly installed at an upper end of the valve body, an oil storage cavity is formed between the outer cylinder barrel, the inner cylinder barrel, and the valve body, a piston rod is slidably disposed in the inner cylinder barrel, a pressure cavity is defined by the piston rod, the inner cylinder barrel, and the valve body, a lower piston is vertically disposed in the base seat in a slidable manner, the lower piston is located below the valve body and is driven to move upward by a foot pedal assembly, a joint is provided below the valve body, an inner piston is slidably disposed in the joint, a first pressurizing cavity is defined by the lower piston, the valve body, the joint, and the base seat, a second pressurizing cavity is defined by the inner piston, the joint, and the valve body, a first oil passage is provided between the first pressurizing cavity and the second pressurizing cavity, and the first pressurizing cavity communicates with the second pressurizing cavity via the first oil passage, the valve body is internally provided with a second oil passage connecting the oil storage cavity and the first pressurizing cavity, an oil inlet passage connecting the second pressurizing cavity and the pressure cavity, and an oil return passage connecting the second pressurizing cavity and the oil storage cavity, an oil passage one-way valve is provided in the first oil passage, an oil passage valve is provided in the second oil passage, an oil inlet valve is provided in the oil inlet passage, an oil return one-way valve is provided in the oil return passage, when the piston rod needs to move upward, the foot pedal assembly drives the lower piston to move upward to compress the first pressurizing cavity, the oil pressure in the first pressurizing cavity causes the oil passage valve to block the second oil passage and the oil passage one-way valve to open the first oil passage, hydraulic oil in the first pressurizing cavity enters the second pressurizing cavity through the first oil passage, the upward movement of the lower piston drives the inner piston to move upward to compress the second pressurizing cavity, the oil pressure in the second pressurizing cavity causes the oil inlet valve to open the oil inlet passage, and hydraulic oil in the second pressurizing cavity enters the pressure cavity through the oil inlet passage; when the piston rod needs to move downward, the foot pedal assembly drives the lower piston to move upward until the inner piston pushes the oil inlet valve to open the oil inlet passage, the oil return one-way valve opens the oil return passage, and hydraulic oil in the pressure cavity returns to the oil storage cavity through the oil inlet passage, the second pressurizing cavity, and the oil return passage.

Optionally, the leg assembly comprises a first leg, a second leg, a first wheel, and a second wheel, wherein the first leg and the second leg are connected to each other, the first wheel is rotatably disposed at a bottom of the first leg, the second wheel is rotatably disposed at an end of the second leg, and an end of the connecting portion is disposed at a connection point between the first leg and the second leg.

The present application provides a handling truck, wherein the moving assembly and the base are in socket engagement, and a connecting member is provided to pass through the base and the moving assembly to achieve a detachable connection between the base and the moving assembly; during transportation, the connecting member is removed from the base and the moving assembly, and then the moving assembly is disassembled from the base, which can reduce the space occupied by the handling truck and thereby lower packaging costs and transportation costs.

### BRIEF DESCRIPTION OF THE DRAWINGS

In order to more clearly illustrate the technical solutions in the embodiments of the present disclosure or in the prior art, the drawings required for use in the description of the embodiments or the prior art will be briefly introduced below. It is apparent that the drawings in the following description are merely some embodiments of the present disclosure, and for those of ordinary skill in the art, other drawings may also be derived based on the structures shown in these drawings without creative effort.

FIG. 1 is a schematic structural view of a handling truck without a load-bearing device installed in one embodiment.

FIG. 2 is a schematic structural view of an mast assembly in one embodiment.

FIG. 3 is a schematic structural view of a fixed member in one embodiment.

FIG. 4 is an enlarged schematic view at portion A in FIG. 3.

FIG. 5 is a first schematic structural view of a handling truck with a load-bearing device installed in one embodiment.

FIG. 6 is a second schematic structural view of a handling truck with a load-bearing device installed in one embodiment.

FIG. 7 is a third schematic structural view of a handling truck with a load-bearing device installed in one embodiment.

FIG. 8 is a perspective view of a driving member of a handling truck in one embodiment.

FIG. 9 is a cross-sectional view of a driving member without a foot pedal assembly and a base frame in one embodiment.

FIG. 10 is a partial cross-sectional view of a driving member from another angle in one embodiment.

FIG. 11 is a perspective view of an adjusting valve core of a driving member in one embodiment.

FIG. 12 is a perspective view of a foot pedal assembly, a base frame, and a lower piston of a driving member in one embodiment.

FIG. 13 is a cross-sectional view of a lower piston and an installation seat of a driving member in one embodiment.

FIG. 14 is a fourth schematic structural view of a handling truck with a load-bearing device installed in one embodiment.

FIG. 15 is a fifth schematic structural view of a handling truck with a load-bearing device installed in one embodiment.

Reference numerals are listed below: 1. mast assembly; 11. fixed member; 111. main channel; 112. first opening; 113. second opening; 114. main body portion; 115. flange portion; 116. auxiliary channel; 117. clearance notch; 12. sliding member; 121. first side wall; 122. interface; 13. driving member; 131. base seat; 132. outer cylinder barrel; 133. valve body; 134. inner cylinder barrel; 135. oil storage cavity; 136. piston rod; 137. pressure cavity; 138. lower piston; 139. joint; 1310. inner piston; 1311. first pressurizing cavity; 1312. second pressurizing cavity; 1313. first oil passage; 1314. second oil passage; 1315. oil inlet passage; 1316. oil return passage; 1317. oil passage one-way valve; 1317a. steel ball; 1317b. eighth spring; 1318. oil passage valve; 1318a. oil passage valve core; 1318b. second spring; 1319. oil inlet valve; 1319a. oil inlet valve core; 1319b. fourth spring; 1320. oil return one-way valve; 1320a. oil return valve core; 1320b. fifth spring; 1321. valve core bore; 1321a. large valve core bore; 1321b. small valve core bore; 1322. oil inlet hole; 1323. oil outlet hole; 1324. adjusting valve core; 1324a. frustum segment; 1324b. first cylindrical segment; 1324c. second cylindrical segment; 1324d. first protruding ring; 1324e. second protruding ring; 1325. first spring; 1326. installation hole; 1327. pressure-reducing valve core; 1328. installation sleeve; 1329. pushing shaft; 1330. third spring; 1331. installation seat; 1331a. bottom plate; 1331b. sleeve portion; 1332. groove; 1333. oil passage hole; 1334. through hole; 1335. sixth spring; 1336. seventh spring; 1337. base frame; 1337a. horizontal installation plate; 1337b. vertical installation plate; 1337c. installation lug; 1338. first hinge seat; 1339. second hinge seat; 1339a. hinge plate; 1339b. connecting plate; 1340. foot pedal; 1341. torsion spring; 1342. limit plate; 1343. front end cover; 1343a. outer sealing portion; 1343b. inner sealing portion; 1343c. limit protruding edge; 1344. sliding column; 1345. installation protruding edge; 1346. oblong hole; 1347. oil discharge passage; 1348. coupling portion; 1349. housing; 1350. foot pedal assembly; 1351. ball expansion plug; 1352. first O-ring; 1353. second O-ring; 1354. third O-ring; 1355. fourth O-ring; 14. bearing; 141. buffer member; 15. handle; 2. base; 21. support rod; 22. connecting rod; 23. socket portion; 3. moving assembly; 31. leg assembly; 32. connecting portion; 33. first leg; 34. second leg; 35. first wheel; 36. second wheel; 4. connecting member; 5. load-bearing device; 51. load-bearing portion; 52. insertion portion; 53. end plate.

The realization, functional features, and advantages of the objectives of the present disclosure will be further described in conjunction with the embodiments and with reference to the accompanying drawings.

### DETAILED DESCRIPTION OF EMBODIMENTS

The technical solutions in the embodiments of the present disclosure will be clearly and completely described below in conjunction with the accompanying drawings in the embodiments of the present disclosure. It is apparent that the described embodiments are merely some embodiments of the present disclosure, rather than all. Based on the embodiments of the present disclosure, all other embodiments obtained by those of ordinary skill in the art without creative effort shall fall within the protection scope of the present disclosure.

It should be noted that all directional indications (such as up, down, left, right, front, rear, etc.) in the embodiments of the present disclosure are only used to explain the relative positional relationships, motion conditions, etc., among the components in a specific orientation (as shown in the accompanying drawings). If the specific orientation changes, the directional indications will change accordingly.

In addition, descriptions involving “first,” “second,” etc., in the present disclosure are for descriptive purposes only and should not be construed as indicating or implying their relative importance or implicitly indicating the number of technical features indicated. Thus, features defined with “first” or “second” may explicitly or implicitly include at least one such feature. Furthermore, “and/or” throughout the text includes three schemes, taking A and/or B as an example, including the technical scheme of A, the technical scheme of B, and the technical scheme where both A and B are satisfied. In addition, the technical schemes between various embodiments can be combined with each other, but must be based on what those of ordinary skill in the art can achieve. When the combination of technical schemes results in mutual contradiction or cannot be achieved, it should be considered that such combination of technical schemes does not exist and is not within the protection scope claimed by the present disclosure.

As used herein, “about,” “substantially,” or “approximately” includes the stated value and averages within an acceptable deviation range from the specific value, where the acceptable deviation range is determined by those of ordinary skill in the art considering the measurement in question and the errors associated with the measurement of the particular quantity (i.e., the limitations of the measurement system).

As used herein, “parallel,” “perpendicular,” or “equal” includes the stated conditions as well as conditions approximate to the stated conditions, the range of such approximate conditions being within an acceptable deviation range, where the acceptable deviation range is determined by those of ordinary skill in the art considering the measurement in question and the errors associated with the measurement of the particular quantity (i.e., the limitations of the measurement system). For example, “parallel” includes absolute parallelism and approximate parallelism, where the acceptable deviation range for approximate parallelism may be, for example, a deviation within 5°; “perpendicular” includes absolute perpendicularity and approximate perpendicularity, where the acceptable deviation range for approximate perpendicularity may also be, for example, a deviation within 5°. “Equal” includes absolute equality and approximate equality, where the acceptable deviation range for approximate equality may be, for example, a difference between the two that are equal being less than or equal to 5% of either one.

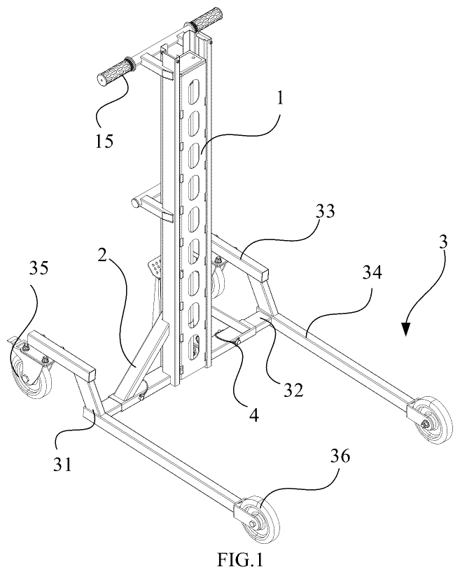

Referring to FIGS. 1 to 7, the present application provides a handling truck, which includes an mast assembly 1, a base 2, a moving assembly 3, and a connecting member 4. The base 2 is fixedly disposed at a bottom end of the mast assembly 1, and the base 2 is provided with a socket portion 23; the moving assembly 3 includes a leg assembly 31 and a connecting portion 32, one end of the connecting portion 32 is connected to the leg assembly 31, the other end of the connecting portion 32 is configured to establish a socket engagement with the socket portion 23, and the moving assembly 3 is configured to drive the mast assembly 1 to move on a plane; the connecting member 4 is configured to pass through the socket portion 23 and the connecting portion 32 to achieve a detachable connection between the moving assembly 3 and the base 2.

The present application provides a handling truck, wherein the moving assembly 3 and the base 2 are in socket engagement, and a connecting member 4 is provided to pass through the base 2 and the moving assembly 3 to achieve a detachable connection between the base 2 and the moving assembly 3; during transportation, the connecting member 4 is removed from the base 2 and the moving assembly 3, and then the moving assembly 3 is disassembled from the base 2, which can reduce the space occupied by the handling truck and thereby lower packaging costs and transportation costs.

Specifically, the mast assembly 1 has an elongated structure, thereby further reducing the space occupied by the handling truck. Furthermore, the base 2 and the mast assembly 1 are fixedly connected in a detachable manner.

In this embodiment, the connecting member 4 is a D-shaped pin, and specifically, the D-shaped pin structure enables quick disassembly and assembly of the moving assembly 3 relative to the base 2.

In other embodiments, the connecting member 4 is a locking nut for axial positioning and radial positioning, further addressing the issue of relative shaking between the moving assembly 3 and the base 2.

In this embodiment, the socket portion 23 is a socket opening, and the other end of the connecting portion 32 is configured to be inserted into the socket opening. In other embodiments, the other end of the connecting portion 32 is provided with a socket opening, and the socket portion 23 is configured to be inserted into the socket opening of the connecting portion 32.

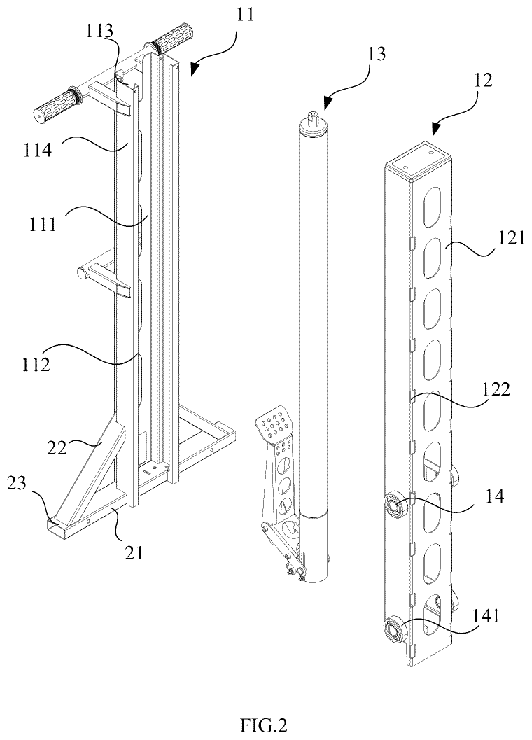

Referring to FIGS. 1 and 2, the base 2 includes a support rod 21 and two connecting rods 22, the support rod 21 is disposed at the bottom end of the mast assembly 1, the two connecting rods 22 are respectively disposed on two sides of the mast assembly 1, the connecting rods 22 are inclined relative to the mast assembly 1, one end of each connecting rod 22 is connected to one end of the support rod 21, the other end of each connecting rod 22 is connected to a side surface of the mast assembly 1, and the connecting rods 22, the mast assembly 1, and the support rod 21 enclose to form a triangular structure to enhance the connection stability between the mast assembly 1 and the base 2.

Specifically, the support rod 21 and the connecting portion 32 are both square tube structures, enabling quick installation and replacement.

Referring to FIGS. 1 and 2, the number of the moving assemblies 3 is two, the two ends of the support rod 21 are respectively provided with a socket portion 23, the two moving assemblies 3 are in socket engagement with the two ends of the support rod 21 respectively via the connecting portions 32; the number of the connecting members 4 is at least two, and each moving assembly 3 corresponds to at least one connecting member 4. In this embodiment, the number of the connecting members 4 is two.

Specifically, the socket portions 23 are formed as axially hollow structures of the support rod 21.

Referring to FIG. 1, the leg assembly 31 includes a first leg 33, a second leg 34, a first wheel 35, and a second wheel 36, the first leg 33 and the second leg 34 are connected to each other, the first wheel 35 is rotatably disposed at a bottom of the first leg 33, the second wheel 36 is rotatably disposed at an end of the second leg 34, and an end of the connecting portion 32 is disposed at a connection point between the first leg 33 and the second leg 34. Specifically, the connecting portion 32 is disposed perpendicular to the first leg 33. In this embodiment, the two second legs 34 are arranged in parallel, and the connecting portion 32 is perpendicular to the second legs 34.

Specifically, to further reduce the space occupied by the handling truck, the first leg 33 and the second leg 34 are detachably connected.

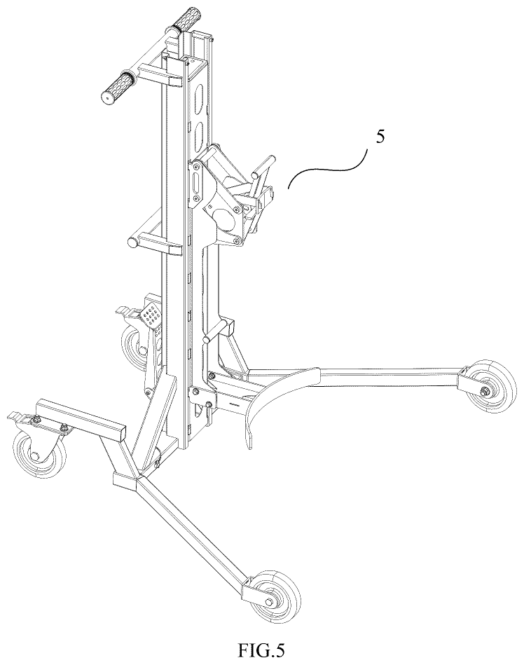

Referring to FIGS. 5 to 7, the handling truck further includes a load-bearing device 5, the load-bearing device 5 is detachably disposed on a side surface of the mast assembly 1, the load-bearing device 5 is configured to carry objects, and the load-bearing device 5 is movable along an axial direction of the mast assembly 1.

Referring to FIGS. 1 to 4, the mast assembly 1 includes a fixed member 11, a sliding member 12, and a driving member 13, a middle portion of the support rod 21 is fixedly connected to a bottom of the fixed member 11, with the fixed member 11 being perpendicular to the support rod 21, an end of each connecting rod 22 is connected to an end of the support rod 21, another end of each connecting rod 22 is connected to a side surface of the fixed member 11, an interior of the fixed member 11 is provided with a main channel 111, a side wall of the fixed member 11 is provided with a first opening 112, a top end of the fixed member 11 is provided with a second opening 113, the main channel 111 communicates with the first opening 112 and the second opening 113, the sliding member 12 is disposed in the main channel 111, the sliding member 12 has a first side wall 121, the first side wall 121 is located within the first opening 112, the load-bearing device 5 is detachably disposed on the first side wall 121, the driving member 13 is disposed inside the sliding member 12 with a top of the driving member 13 connected to a top of the sliding member 12, and the driving member 13 is capable of extending and retracting along its own axial direction to thereby drive the sliding member 12 and the load-bearing device 5 to reciprocate up and down along the main channel 111.

Specifically, the fixed member 11 and the sliding member 12 are both internally hollow structures, and the fixed member 11 and the sliding member 12 are substantially rectangular prism-shaped.

Specifically, the second opening 113 provided at the top end of the fixed member 11 does not obstruct the upward movement of the sliding member 12.

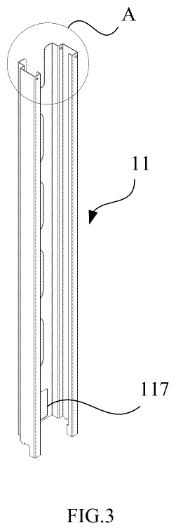

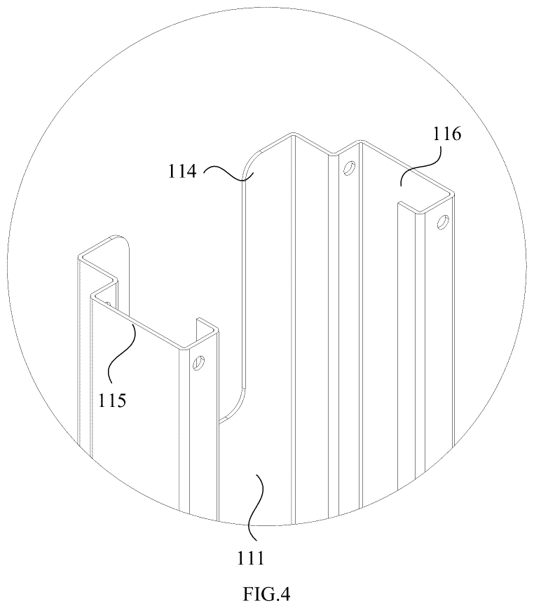

Referring to FIGS. 3 and 4, the fixed member 11 includes a main body portion 114 and two flange portions 115, the main body portion 114 defines the main channel 111, the two flange portions 115 are disposed on two opposite side walls of the main body portion 114, each of the two flange portions 115 defines an auxiliary channel 116, the auxiliary channels 116 communicate with the main channel 111, and the auxiliary channels 116 extend along a length direction of the main channel 111.

Specifically, the flange portions 115 are rectangular prism-shaped.

Referring to FIG. 2, the mast assembly 1 further includes at least two bearings 14, the two bearings 14 are respectively disposed on two opposite side walls of the sliding member 12, each bearing 14 is disposed in a corresponding one of the auxiliary channels 116 to thereby attach the sliding member 12 to the fixed member 11, and the bearings 14 enable the sliding member 12 to move up and down within the fixed member 11 along the main channel 111.

In this embodiment, the number of the bearings 14 is four.

The mast assembly 1 further includes buffer members 141, the buffer members 141 cover outer rings of the bearings 14, and each bearing 14 is covered with a buffer member 141.

Specifically, the buffer members 141 are made of nylon material.

When an attachment is hung on the front side of the main body portion 114 and loaded with heavy objects, the center of gravity of the heavy objects is located at outer side the main body portion 114, causing the main body portion 114 as a whole to be subjected to an overturning moment. This moment is transmitted to the contact surfaces between the four bearings and the auxiliary channels 116. When the outer rings of the bearings 14 are in direct contact with the surfaces of the auxiliary channels 116, due to the high hardness of the material of the outer rings of the bearings 14, the contact stress on the contact surfaces between the bearings 14 and the auxiliary channels 116 is very high, resulting in stress concentration. After repeated rolling and crushing by the bearings 14, this can lead to wear, deformation, tearing, and other failures in the auxiliary channels 116. The present application adds a layer of nylon sleeve as a buffer on the outer rings of the bearings 14 to avoid direct contact between the bearings 14 and the auxiliary channels 116. Since the hardness of the nylon material is much lower than that of the outer rings of the bearings, the contact stress experienced by the auxiliary channels 116 is significantly reduced, avoiding failures.

Referring to FIGS. 1, 2, and 6, the first side wall 121 is provided with a plurality of interfaces 122, the plurality of interfaces 122 are spaced apart and spread along a height direction of the first side wall 121, the load-bearing device 5 includes a load-bearing portion 51 and an insertion portion 52, the load-bearing portion 51 and the insertion portion 52 are connected to each other, the load-bearing portion 51 is configured to load objects, and the insertion portion 52 is configured to be inserted into the interfaces 122 to achieve a detachable connection between the load-bearing device 5 and the sliding member 12.

In this embodiment, two spaced-apart interfaces 122 form one group, and multiple groups of interfaces 122 are spaced apart and spread along the height direction of the first side wall 121. The attachment, i.e., the load-bearing device 5, can be quickly installed via the interfaces on the sliding member 12, and by providing multiple groups of interfaces 122, the installation position of the load-bearing device 5 can be adjusted according to the required height.

Specifically, the load-bearing portion 51 includes a oil drum gripper, a load-bearing plate, and a fork component. By providing standardized interfaces 122, different load-bearing portions 51 can be used to achieve different functions, suitable for handling heavy objects in various work scenarios.

In another embodiment, referring to FIG. 5, when the load-bearing portion 51 is an oil drum gripper, the load-bearing device 5 is configured to grip oil drums. The two first legs 33 are arranged in parallel, the two second legs 34 are symmetrically disposed on two sides of the mast assembly 1, the spacing between the ends of the two second legs 34 provided with the second wheels 36 is greater than the spacing between the ends of the two second legs 34 connected to the connecting portions 32, and the two second legs 34 and the support rod 21 enclose a shape that is substantially an isosceles trapezoid. The first wheels 35 and the second wheels 36 are of the same specification and model. This structure provides a wider load-bearing surface, preventing the equipment from tilting or losing balance, thereby ensuring safety and precision during the drum gripping process.

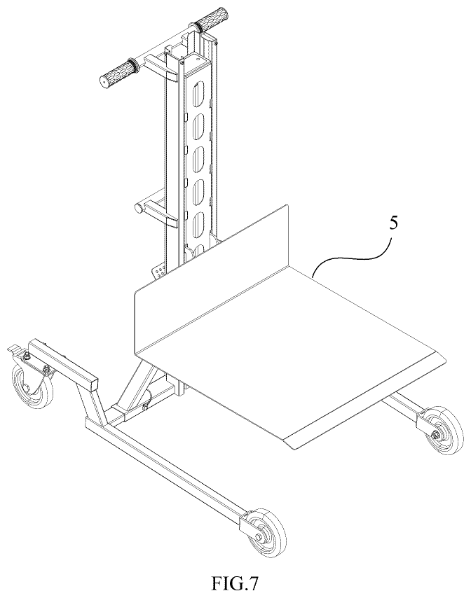

Referring to FIG. 7, when the load-bearing portion 51 is a load-bearing plate, it is used for loading heavy objects or pallets. The two first legs 33 are arranged in parallel, the two second legs 34 are arranged in parallel, and the first wheels 35 and the second wheels 36 are of the same specification and model.

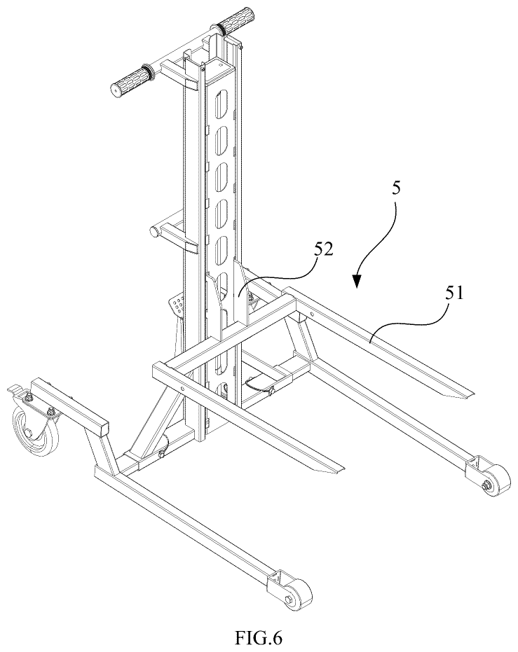

Referring to FIG. 6, when the load-bearing portion 51 is a fork component, it is used for loading cement or fertilizer. The two first legs 33 are arranged in parallel, the two second legs 34 are arranged in parallel, and the diameter of the second wheels 36 is smaller than the diameter of the first wheels 35. The smaller diameter of the second wheels 36 compared to the first wheels 35 ensures a lower center of gravity. This design helps reduce the risk of tilting during forking or moving heavy objects. The smaller second wheels 36 allow the equipment to be more flexible during turns, particularly when operating in confined spaces, providing better maneuverability.

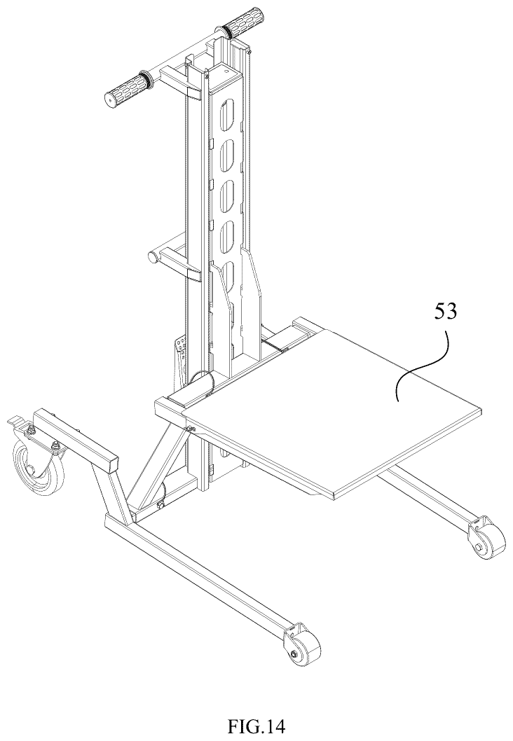

In another embodiment, referring to FIG. 14, unlike the embodiment of FIG. 6, the fork component in this embodiment further includes an end plate 53, which is used for holding items.

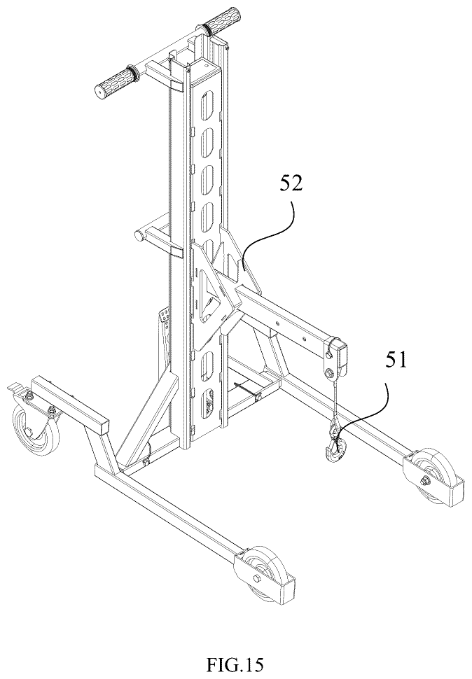

In another embodiment, referring to FIG. 15, unlike the embodiment of FIG. 7, the load-bearing portion 51 in this embodiment is a lifting hook, used for lifting and transporting heavy objects.

Referring to FIGS. 1 and 2, the mast assembly 1 further includes a handle 15, the handle 15 is disposed on a side wall of the fixed member 11 distal to the first opening 112. The configuration with the handle 15 facilitates the pushing of the handling truck by an operator.

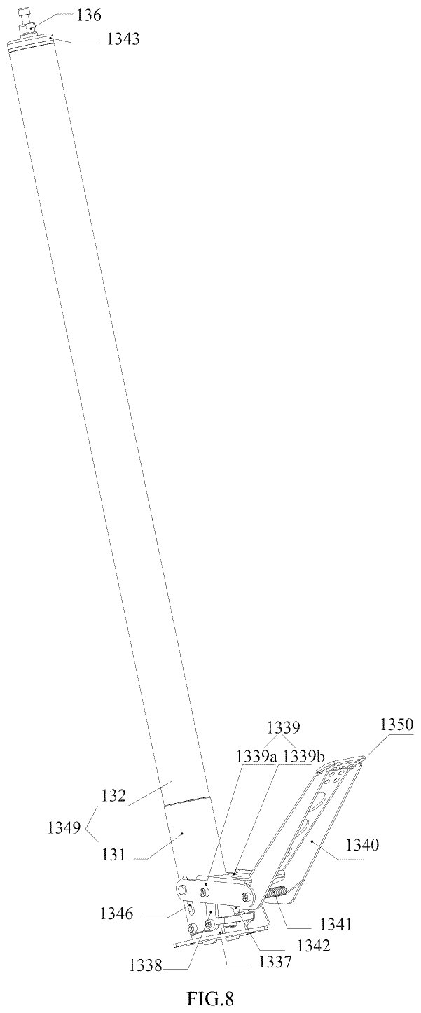

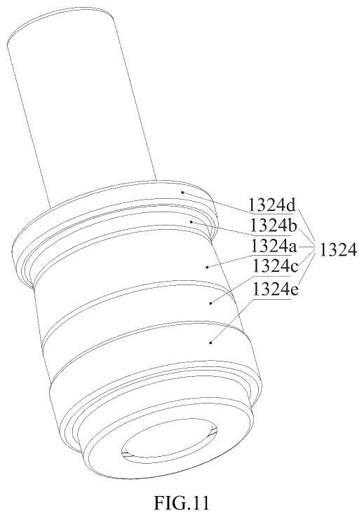

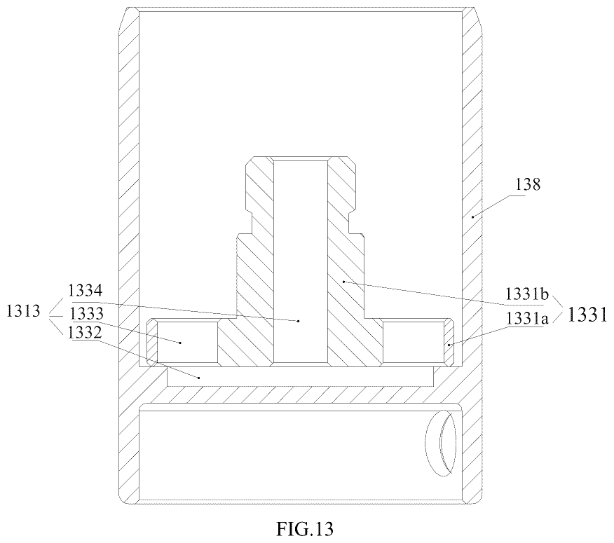

Referring to FIGS. 8 to 13, the driving member 13 includes a hydraulic cylinder and a foot pedal assembly 1350. The hydraulic cylinder includes a housing 1349 composed of a base seat 131 and an outer cylinder barrel 132, the foot pedal assembly 1350 is disposed at a lower end of the base seat 131, a valve body 133 is fixedly installed inside the housing 1349, an inner cylinder barrel 134 located inside the outer cylinder barrel 132 is fixedly installed at an upper end of the valve body 133, an oil storage cavity 135 is defined by the outer cylinder barrel 132, the inner cylinder barrel 134, and the valve body 133, a piston rod 136 is slidably disposed in the inner cylinder barrel 134, a pressure cavity 137 is defined by the piston rod 136, the inner cylinder barrel 134, and the valve body 133, a lower piston 138 is vertically disposed in the base seat 131 in a slidable manner, the lower piston 138 is located below the valve body 133 and is driven to move upward by the foot pedal assembly 1350, a joint 139 is provided below the valve body 133, an inner piston 1310 is slidably disposed in the joint 139, a first pressurizing cavity 1311 is defined by the lower piston 138, the valve body 133, the joint 139, and the base seat 131, a second pressurizing cavity 1312 is defined by the inner piston 1310, the joint 139, and the valve body 133, the first pressurizing cavity 1311 communicates with the second pressurizing cavity 1312 via a first oil passage 1313, the valve body 133 is internally provided with a second oil passage 1314, the oil storage cavity 135 communicates with the first pressurizing cavity 1311 via the second oil passage 1314, the second pressurizing cavity 1312 communicates with the pressure cavity 137 via an oil inlet passage 1315, and the second pressurizing cavity 1312 communicates with the oil storage cavity 135 via an oil return passage 1316, an oil passage one-way valve 1317 is provided in the first oil passage 1313, an oil passage valve 1318 is provided in the second oil passage 1314, an oil inlet valve 1319 is provided in the oil inlet passage 1315, an oil return one-way valve 1320 is provided in the oil return passage 1316, when the piston rod 136 needs to move upward, the foot pedal assembly 1350 drives the lower piston 138 to move upward to compress the first pressurizing cavity 1311, the oil pressure in the first pressurizing cavity 1311 causes the oil passage valve 1318 to block the second oil passage 1314 and the oil passage one-way valve 1317 to open the first oil passage 1313, hydraulic oil in the first pressurizing cavity 1311 enters the second pressurizing cavity 1312 through the first oil passage 1313, the upward movement of the lower piston 138 drives the inner piston 1310 to move upward to compress the second pressurizing cavity 1312, the oil pressure in the second pressurizing cavity 1312 causes the oil inlet valve 1319 to open the oil inlet passage 1315, and hydraulic oil in the second pressurizing cavity 1312 enters the pressure cavity 137 through the oil inlet passage 1315; when the piston rod 136 needs to move downward, the foot pedal assembly 1350 drives the lower piston 138 to move upward until the inner piston 1310 pushes the oil inlet valve 1319 to open the oil inlet passage 1315 and the oil return one-way valve 1320 opens the oil return passage 1316, and hydraulic oil in the pressure cavity 137 returns to the oil storage cavity 135 through the oil inlet passage 1315, the second pressurizing cavity 1312, and the oil return passage 1316.

The working principle of the present disclosure is discussed below. As shown in FIGS. 8-13, by stepping on the foot pedal assembly 1350, the foot pedal assembly 1350 drives the lower piston 138 to move upward, compressing the first pressurizing cavity 1311, the oil pressure in the first pressurizing cavity 1311 causes the oil passage valve 1318 to block the second oil passage 1314 and the oil passage one-way valve 1317 to open the first oil passage 1313, hydraulic oil in the first pressurizing cavity 1311 enters the second pressurizing cavity 1312 through the first oil passage 1313, the upward movement of the lower piston 138 drives the inner piston 1310 to move upward, compressing the second pressurizing cavity 1312, the oil pressure in the second pressurizing cavity 1312 causes the oil inlet valve 1319 to open the oil inlet passage 1315, and hydraulic oil in the second pressurizing cavity 1312 enters the pressure cavity 137 through the oil inlet passage 1315, pushing the piston rod 136 to move upward.

Then, by forcefully stepping on the foot pedal assembly 1350, the foot pedal assembly 1350 drives the lower piston 138 to move upward until the inner piston 1310 pushes the oil inlet valve 1319 to open the oil inlet passage 1315 and the oil return one-way valve 1320 opens the oil return passage 1316, and hydraulic oil in the pressure cavity 137 returns to the oil storage cavity 135 through the oil inlet passage 1315, the second pressurizing cavity 1312, and the oil return passage 1316, causing the piston rod 136 to move downward slowly.

The structure of the present disclosure is compact, easy to operate, and the upward and downward movement of the piston rod requires only the operation of the foot pedal assembly 1350 without separate operations.

During heavy loads, due to the high oil pressure in the pressure cavity 137, the flow rate of hydraulic oil in the oil return passage is high, which could cause the piston rod 136 to descend rapidly.

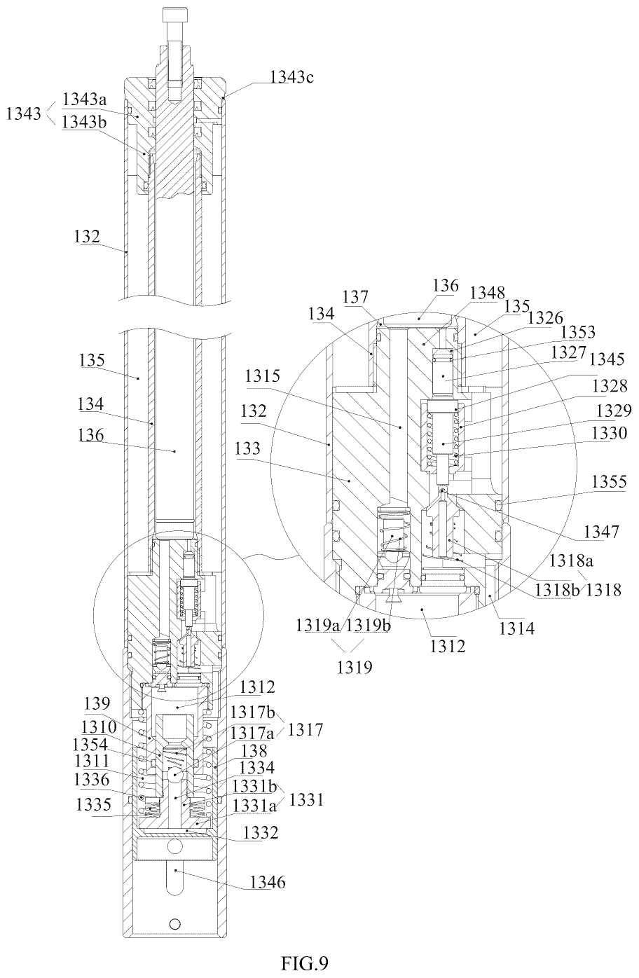

To ensure that during heavy loads, the piston rod 136 does not descend rapidly due to high oil pressure, as shown in FIGS. 9-11, the valve body 133 is internally provided with a valve core bore 1321, the side wall of the valve core bore 1321 is provided with an oil inlet hole 1322 and an oil outlet hole 1323 that communicate with the oil return passage 1316 and are oppositely disposed, an adjusting valve core 1324 is slidably disposed in the valve core bore 1321 along an axial direction, the valve core bore 1321 at a side of the adjusting valve core 1324 communicates with the oil storage cavity 135, the valve core bore 1321 at the other side communicates with the oil inlet passage 1315, the adjusting valve core 1324 includes a frustum segment 1324a disposed opposite to the oil inlet hole 1322, and the diameter of the frustum segment 1324a gradually increases from the side of the valve core bore 1321 communicating with the oil storage cavity 135 to the other side. During heavy loads, the oil pressure in the pressure cavity 137 is high, i.e., the oil pressure in the oil inlet passage 1315 is high, and the oil flow rate increases, causing the adjusting valve core 1324 to move toward a side where the oil storage cavity 135 is located under the push of the oil pressure in the oil inlet passage 1315, the diameter of the part of the frustum segment 1324a opposite the oil inlet hole 1322 increases, reducing the oil inlet area entering the oil inlet hole 1322 from the oil return passage 1316 and the oil outlet area entering the oil storage cavity 135 through the oil outlet hole 1323, thereby keeping the amount of hydraulic oil returning from the pressure cavity 137 to the oil storage cavity 135 constant, allowing the piston rod 136 to descend at a constant speed during heavy loads, i.e., enabling the piston rod 136 to descend at a constant speed during both light and heavy loads.

To allow the piston rod 136 to descend quickly under no-load conditions, a first spring 1325 is provided in the valve core bore 1321 to provide elastic force to move the adjusting valve core 1324 toward a side where the oil inlet passage 1315 is located, the adjusting valve core 1324 further includes a first cylindrical segment 1324b with a diameter equal to the minimum diameter of the frustum segment 1324a and a second cylindrical segment 1324c with a diameter equal to the maximum diameter of the frustum segment 1324a, the first cylindrical segment 1324b is connected to the frustum segment 1324a at a position with the minimum diameter, the second cylindrical segment 1324c is connected to the the frustum segment 1324a at a position with the maximum diameter, the adjusting valve core 1324 is provided with a first protruding ring 1324d and a second protruding ring 1324e that abut and seal against the side wall of the valve core bore 1321, the first protruding ring 1324d is located on the side of the first cylindrical segment 1324b distal to the frustum segment 1324a, and the second protruding ring 1324e is located on the side of the second cylindrical segment 1324c distal to the frustum segment 1324a.

Furthermore, the hydraulic cylinder further includes a ball expansion plug 1351, the ball expansion plug 1351 is located in the valve core bore 1321, the axial direction of the valve core bore 1321 is vertically arranged and the valve core bore 1321 includes a large valve core bore 1321a and a small valve core bore 1321b, the adjusting valve core 1324 and the first spring 1325 are disposed in the large valve core bore 1321a, the upper end of the large valve core bore 1321a communicates with the oil storage cavity 135, a sliding column 1344 is provided within the adjusting valve core 1324, the upper end of the sliding column 1344 is inserted into the adjusting valve core 1324, the lower end of the sliding column 1344 is slidably disposed in the small valve core bore 1321b and is located above the ball expansion plug 1351, and the lower end of the small valve core bore 1321b communicates with the oil inlet passage 1315.

To better seal the gap between the sliding column 1344 and the small valve core bore 1321b, the sliding column 1344 is sleeved with a first O-ring 1352 that seals the gap between the sliding column 1344 and the small valve core bore 1321b.

Structure of the oil passage valve 1318 is discussed below. As shown in FIG. 9, the oil passage valve 1318 includes an oil passage valve core 1318a for blocking and opening the second oil passage 1314 and a second spring 1318b that provides elastic force to return the oil passage valve core 1318a toward a side where the oil storage cavity 135 is located. The valve body 133 is internally provided with an installation hole 1326, a pressure-reducing valve core 1327 is slidably disposed in the installation hole 1326, the installation hole 1326 at a side of the pressure-reducing valve core 1327 communicates with the pressure cavity 137, and an end of the pressure-reducing valve core 1327 distal to the pressure cavity 137 is connected to the oil passage valve core 1318a. During heavy loads, the pressure-reducing valve core 1327 pushes the oil passage valve core 1318a to open the second oil passage 1314, allowing the first pressurizing cavity 1311 to depressurize, thereby enabling upward movement with less force driving the foot pedal during heavy loads. During heavy loads, the high oil pressure in the pressure cavity 137 causes the pressure-reducing valve core 1327 to move toward a side where the oil passage valve core 1318a is located and push the oil passage valve core 1318a to open the second oil passage 1314, so that during the upward movement of the lower piston 138, hydraulic oil in the first pressurizing cavity 1311 returns to the oil storage cavity 135 through the second oil passage 1314, depressurizing the first pressurizing cavity 1311. At this time, the oil passage one-way valve 1317 closes the first oil passage 1313, preventing hydraulic oil in the first pressurizing cavity 1311 from entering the second pressurizing cavity 1312, thereby reducing the amount of hydraulic oil entering the pressure cavity 137, facilitating the upward movement of the lower piston 138 and the inner piston 1310 with less effort, though requiring multiple repeated operations of the foot pedal assembly 1350.

During light loads, the first pressurizing cavity 1311 and the second pressurizing cavity 1312 operate simultaneously, allowing the piston rod 136 to ascend quickly.

Connection structure of the pressure-reducing valve core 1327 and the oil passage valve core 1318a is discussed below. As shown in FIG. 9, the valve body 133 is provided with an installation sleeve 1328, a pushing shaft 1329 is slidably disposed in the installation sleeve 1328, the pushing shaft 1329 is located between the pressure-reducing valve core 1327 and the oil passage valve core 1318a, and a third spring 1330 is sleeved over the pushing shaft 1329, and third spring 1330 provides elastic force to move the pushing shaft 1329 toward a side where the pressure-reducing valve core 1327 is located.

Installation structure of the pushing shaft 1329 and the third spring 1330 is discussed below. The axial direction of the installation hole 1326 is vertically arranged, an upper end of the installation sleeve 1328 is provided with an opening, and its lower end face is provided with an assembly hole for the pushing shaft 1329 to extend through. An upper end of the pushing shaft 1329 is provided with an installation protruding edge 1345, an upper end of the third spring 1330 abuts the installation protruding edge 1345, and a lower end of the third spring 1330 abuts the lower end face of the installation sleeve 1328.

To better seal the gap between the pressure-reducing valve core 1327 and the installation hole 1326, the pressure-reducing valve core 1327 is sleeved with a second O-ring 1353 that seals the gap between the pressure-reducing valve core 1327 and the installation hole 1326.

Under no-load conditions, after the piston rod 136 reaches the top, the pressure cavity 137 is filled with hydraulic oil, and the hydraulic oil in the second pressurizing cavity 1312 cannot enter the pressure cavity 137 anymore. Continuing to step on the foot pedal assembly 1350 causes the oil pressure in the second pressurizing cavity 1312 to push the oil return valve 1318 to open the oil return passage 1316, allowing hydraulic oil in the second pressurizing cavity 1312 to enter the oil storage cavity 135 through the oil return passage 1316. The oil pressure in the first pressurizing cavity 1311 pushes the oil passage one-way valve 1317 to open the first oil passage 1313, allowing hydraulic oil in the first pressurizing cavity 1311 to enter the second pressurizing cavity 1312 through the first oil passage 1313.

To reduce the force required to operate the foot pedal assembly 1350 during no-load conditions, the oil passage valve core 1318a is internally provided with an oil discharge passage 1347, the oil storage cavity 135 communicates with the first pressurizing cavity 1311 via the oil discharge passage 1347. When depressurization is needed when there is no load, hydraulic oil in the first pressurizing cavity 1311 returns to the oil storage cavity 135 through the oil discharge passage 1347, reducing the amount of oil entering the oil storage cavity 135 through the oil return passage 1316 from the second pressurizing cavity 1312.

Specific structure of the oil discharge passage 1347 is discussed below. The axial direction of the oil passage valve core 1318a is vertically arranged, the oil discharge passage 1347 includes a vertical hole arranged along the axial direction of the oil passage valve core 1318a and a horizontal hole arranged perpendicular to the axial direction of the oil passage valve core 1318a, the diameter of the horizontal hole ranges from 0.6 mm to 0.8 mm, the vertical hole is a stepped hole including a small hole at an upper side and a large hole below the small hole, the horizontal hole is connected to the side wall of the small hole, the diameter of the small hole ranges from 1.0 mm to 1.4 mm, and the diameter of the large hole ranges from 2.0 mm to 2.4 mm. The oil flow rate through the oil discharge passage 1347 is much smaller than the oil flow rate that the pressure-reducing valve core 1327 required to push the oil passage valve core 1318a to open the second oil passage 1314, having minimal impact on the amount of oil entering the pressure cavity 137 during the upward movement of the piston rod 136.

In this embodiment, the diameter of the horizontal hole is 0.7 mm, the diameter of the small hole is 1.2 mm, and the diameter of the large hole is 2.2 mm.

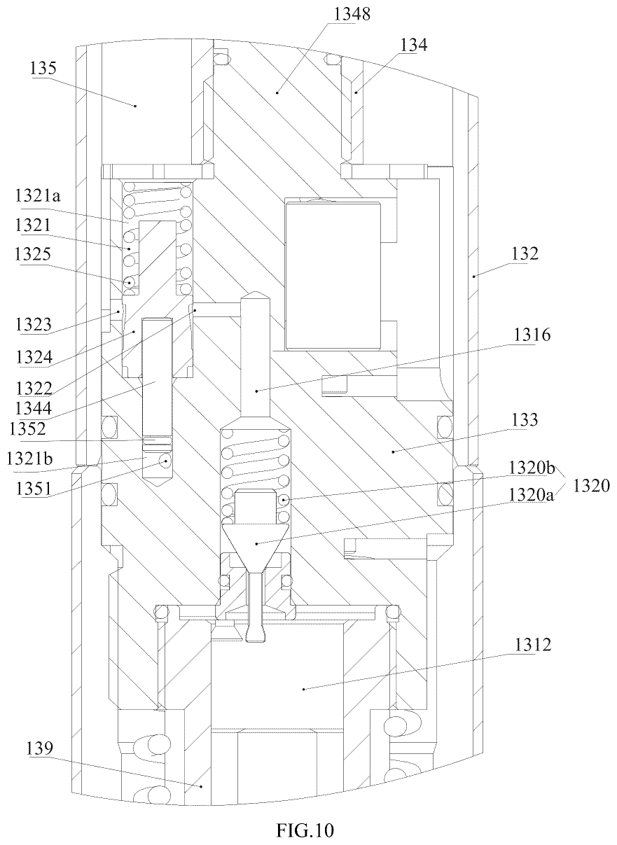

Specific structure of the oil inlet valve 1319 and the oil return one-way valve 1320 is discussed below. As shown in FIGS. 9 and 10, the oil inlet valve 1319 includes an oil inlet valve core 1319a for blocking and opening the oil inlet passage 1315 and a fourth spring 1319b that provides elastic force to return the oil inlet valve core 1319a toward a side where the second pressurizing cavity 1312 is located, with the end of the oil inlet valve core 1319a proximal to the second pressurizing cavity 1312 extending out of the valve body 133; the oil return one-way valve 1320 includes an oil return valve core 1320a for blocking and opening the oil return passage 1316 and a fifth spring 1320b that provides elastic force to return the oil return valve core 1320a toward a side where the second pressurizing cavity 1312 is located, with the end of the oil return valve core 1320a proximal to the second pressurizing cavity 1312 extending out of the valve body 133; the elastic force of the fourth spring 1319b is significantly less than that of the fifth spring 1320b; when the inner piston 1310 moves upward and pushes the oil inlet valve core 1319a and the oil return valve core 1320a to move into the valve body 133, the oil inlet valve core 1319a opens the oil inlet passage 1315, and the oil return valve core 1320a opens the oil return passage 1316.

When the inner piston 1310 does not push the oil inlet valve core 1319a and the oil return valve core 1320a to move into the valve body 133, due to the elastic force of the fourth spring 1319b being significantly less than that of the fifth spring 1320b, the oil pressure in the second pressurizing cavity 1312 typically only causes the oil inlet valve core 1319a to open the oil inlet passage 1315 and cannot cause the oil return valve core 1320a to open the oil return passage 1316.

Furthermore, the elastic force of the fifth spring 1320b is greater than or equal to 10 times that of the fourth spring 1319b. In this embodiment, the elastic force of the fifth spring 1320b is 100 N, and the elastic force of the fourth spring 1319b is 6 N.

Structure of the lower piston 138 and the first oil passage 1313 is discussed below. As shown in FIGS. 9, 10, and 13, the lower piston 138 is cylindrical with an opening facing upward and a hollow interior, an installation seat 1331 is provided inside the lower piston 138, the installation seat 1331 includes a bottom plate 1331a and a sleeve portion 1331b located above the bottom plate 1331a, a recess 1332 is formed by concaving an inner end face of the lower piston 138, the bottom plate 1331a is provided with an oil passage hole 1333, the first pressurizing cavity 1311 communicates with the recess 1332 via the oil passage hole 1333, an upper end of the sleeve portion 1331b is fixedly connected to a lower end of the inner piston 1310, and the upper end of the sleeve portion 1331b is received inside the inner piston 1310, the installation seat 1331 is internally provided with a through hole 1334, the recess 1332 communicates with the second pressurizing cavity 1312 via the through hole 1334, the oil passage hole 1333, the recess 1332, and the through hole 1334 collectively form the first oil passage 1313, the oil passage one-way valve 1317 is disposed in the through hole 1334, a sixth spring 1335 is sleeved over the sleeve portion 1331b and the sixth spring 1335 is located between the inner piston 1310 and the bottom plate 1331a, when the inner piston 1310 pushes the oil inlet valve 1319 and the oil return one-way valve 1320, a lower end of the joint 139 abuts the sixth spring 1335, making the foot pressing force required for the downward movement of the piston rod 136 greater than that for the upward movement, thereby allowing the operator to distinguish whether the foot press causes the piston rod 136 to move upward or downward.

Connection method of the sleeve portion 1331b and the inner piston 1310 is discussed below. The sleeve portion 1331b is screwed to the inner piston 1310.

Structure of the oil passage one-way valve 1317 is discussed below. The axial direction of the through hole 1334 is vertically arranged, the oil passage one-way valve 1317 includes a steel ball 1317a disposed on the installation seat 1331 for blocking and opening the through hole 1334 and an eighth spring 1317b that provides elastic force to return the steel ball 1317a downward.

Furthermore, the sixth spring 1335 is a belleville spring washer.

For better sealing effect, an O-ring that seals the gap between the lower piston 138 and the base seat 131 is sleeved over the lower piston 138, and a third O-ring 1354 that seals the gap between the inner piston 1310 and the joint 139 is sleeved over inner piston 1310.

For better sealing effect, a lower end of the valve body 133 is screwed to an upper end of the base seat 131, an upper end of the valve body 133 is located inside the outer cylinder barrel 132, an O-ring that seals the gap between the base seat 131 and the valve body 133 and a fourth O-ring 1355 that seals the gap between the outer cylinder barrel 132 and the valve body 133 are sleeved over the valve body 133.

To allow the installation seat 1331 and the lower piston 138 to automatically return downward when the foot pedal assembly 1350 is released, a seventh spring 1336 is sleeved over the joint 139, with an upper end of the seventh spring 1336 abutting the valve body 133 and a lower end of the seventh spring 1336 abutting the bottom plate 1331a. When the foot pedal assembly 1350 is released, the bottom plate 1331a moves downward under the elastic force of the seventh spring 1336, thereby driving the installation seat 1331 and the inner piston 1310 to move downward, increasing the space of the first pressurizing cavity 1311 and the second pressurizing cavity 1312, causing the oil passage valve 1318 to open the second oil passage 1314 and the oil passage one-way valve 1317 to open the first oil passage 1313, allowing hydraulic oil in the oil storage cavity 135 to enter the first pressurizing cavity 1311 through the second oil passage 1314 and then enter the second pressurizing cavity 1312 through the first oil passage 1313.

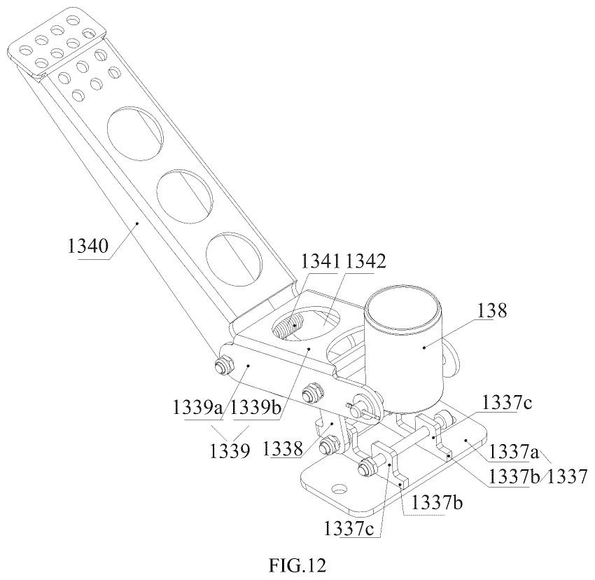

To reduce the lateral space occupied by the foot pedal assembly 1350, as shown in FIGS. 8 and 12, the foot pedal assembly 1350 includes a base frame 1337 installed below the base seat 131, a first hinge seat 1338 with its lower end hinged to the base frame 1337, a second hinge seat 1339, and a foot pedal 1340. An upper end of the first hinge seat 1338 is hinged to the second hinge seat 1339, an end of the second hinge seat 1339 is hinged to the lower piston 138, and another end of the second hinge seat 1339 is hinged to an end of the foot pedal 1340. A torsion spring 1341 is mounted on a hinge shaft between the second hinge seat 1339 and the foot pedal 1340, configured to bias the foot pedal 1340 toward upward rotation, and an end portion of the foot pedal 1340 hinged to the second hinge seat 1339 is provided with a limit plate 1342 that abuts and limits the second hinge seat 1339. The configuration of the limit plate 1342 results in a spoon-shaped bend in the side profile of the foot pedal 1340. During use, stepping on the foot pedal 1340 causes it to rotate downward about the hinge shaft connected to the second hinge seat 1339 until the limit plate 1342 abuts the second hinge seat 1339. Continuing to step on the foot pedal 1340 causes an end of the second hinge seat 1339 hinged to the lower piston 138 to move upward about the hinge shaft between the second hinge seat 1339 and the first hinge seat 1338, thereby driving the lower piston 138 to move upward. When the foot pedal 1340 is released, the foot pedal 1340 rotates upward and resets under the elastic force of the torsion spring 1341, completing the storage of the foot pedal 1340.

Specifically, the foot pedal 1340 partially extends outside the main channel 111, and the side wall of the main body portion 114 is provided with a clearance notch 117 for accommodating the foot pedal 1340. By stepping on the foot pedal 1340, the upward or downward movement of the sliding member 12 is controlled.

The foot pedal assembly 1350 of the present disclosure adopts a foldable mechanism design. During operation, the foot pedal 1340 unfolds for normal use, and when not in operation, the foot pedal 1340 automatically folds, saving space.

Furthermore, the hinge between the foot pedal 1340 and the second hinge seat 1339 employs a self-lubricating bushing structure, enabling smooth unfolding and folding while extending service life.

Hinge structure between the second hinge seat 1339 and the lower piston 138 is discussed below. The lower piston 138 further includes a connecting sleeve disposed below the cylindrical body, the base seat 131 is provided with two oblong holes 1346 with their length direction arranged vertically, and the two oblong holes 1346 are oppositely disposed, the second hinge seat 1339 includes two hinge plates 1339a respectively located on two sides of the base seat 131 and a connecting plate 1339b connecting the two hinge plates 1339a, and the hinge shaft between the second hinge seat 1339 and the lower piston 138 sequentially passes through one hinge plate 1339a, one oblong hole 1346, the connecting sleeve, the other oblong hole 1346, and the other hinge plate 1339a.

Structure of the base frame 1337 is discussed below. The base frame 1337 includes a horizontal installation plate 1337a and two vertical installation plates 1337b, each vertical installation plate 1337b is provided with two installation lugs 1337c, a lower end of the first hinge seat 1338 is hinged within one of the installation lugs 1337c, the other installation lug 1337c extends into the base seat 131 and is hinged to the base seat 131, and a gap of 0.8 mm to 1.2 mm is maintained between a bottom surface of the base seat 131 and the vertical installation plates 1337b, allowing the base seat 131 to rotate slightly relative to the base frame 1337.

Furthermore, an upper end of the outer cylinder barrel 132 is provided with a front end cover 1343, the front end cover 1343 includes an outer sealing portion 1343a and an inner sealing portion 1343b, the outer sealing portion 1343a is disposed inside the outer cylinder barrel 132, and an outer side wall of the outer sealing portion 1343a is sealingly connected to the inner side wall of the outer cylinder barrel 132, the upper end of the inner cylinder barrel 134 is disposed inside the inner sealing portion 1343b, and an inner side wall of the inner sealing portion 1343b is sealingly engaged with an outer side wall of the inner cylinder barrel 134, an upper end of the piston rod 136 extends out of the front end cover 1343, and an outer side wall of the piston rod 136 abuts and connects with an inner side wall of the front end cover 1343.

Installation structure of the outer cylinder barrel 132 and the inner cylinder barrel 134 is discussed below. A coupling portion 1348 is provided in the middle of an upper end of the valve body 133, an upper end of the inner cylinder barrel 134 is screwed to the inner sealing portion 1343b, and a lower end of the inner cylinder barrel 134 is screwed to the coupling portion 1348, an outer periphery of the outer sealing portion 1343a is provided with a limit protruding edge 1343c, and the outer cylinder barrel 132 is axially limited between the limit protruding edge 1343c and the base seat 131.

For better sealing effect, an O-ring that seals the gap between the outer cylinder barrel 132 and the outer sealing portion 1343a is sleeved over the outer sealing portion 1343a, an O-ring that seals the gap between the inner sealing portion 1343b and the inner cylinder barrel 134 is sleeved over the inner cylinder barrel 134, and an O-ring that seals the gap between the piston rod 136 and the front end cover 1343 is sleeved over the piston rod 136.

Furthermore, the first spring 1325, the second spring 1318b, the third spring 1330, the fourth spring 1319b, the fifth spring 1320b, and the seventh spring 1336 are compression springs.

The present disclosure enables automatic switching for pedal stepping force and lifting speed between light-load and heavy-load modes; to ensure safety, constant-speed descent is achievable during lowering operations.

The handling truck of the present application, with standardized interfaces and different attachments or legs, can achieve various functions, suitable for handling heavy objects in different work scenarios. The detachable legs and attachments significantly reduce packaging volume.

The above are only preferred embodiments of the present disclosure and do not limit the patent scope of the present disclosure. Any equivalent structural transformations made under the inventive concept of the present disclosure using the contents of the specification and drawings, or direct/indirect applications in other related technical fields, are included in the patent protection scope of the present disclosure.

What is claimed is:

1. A handling truck, comprising:
a mast assembly;
a base, fixedly disposed at a bottom end of the mast assembly, wherein the base is provided with a socket portion;
a moving assembly, wherein the moving assembly comprises a leg assembly and a connecting portion, a first end of the connecting portion is connected to the leg assembly, a second end of the connecting portion is configured for socket engagement with the socket portion, and the moving assembly is configured to drive the mast assembly to move on a plane; and
a connecting member, wherein the connecting member is configured to pass through the socket portion and the connecting portion to achieve a detachable connection between the moving assembly and the base.

2. The handling truck according to claim 1, wherein the handling truck further comprises a load-bearing device, wherein the load-bearing device is detachably disposed on a side surface of the mast assembly, the load-bearing device is configured to carry objects, and the load-bearing device is movable along an axial direction of the mast assembly.

3. The handling truck according to claim 2, wherein the mast assembly comprises a fixed member, a sliding member, and a driving member, wherein the base is disposed at a bottom of the fixed member, an interior of the fixed member is provided with a main channel, the fixed member is provided with a first opening, the main channel communicates with the first opening, the sliding member is disposed in the main channel, the sliding member has a first side wall, the first side wall is disposed facing the first opening, the load-bearing device is detachably disposed on the first side wall, the driving member is disposed inside the sliding member with a top of the driving member connected to a top of the sliding member, and the driving member is capable of extending and retracting along its own axial direction to thereby drive the sliding member and the load-bearing device to move along the main channel.

4. The handling truck according to claim 3, wherein the first side wall is provided with a plurality of interfaces, wherein the plurality of interfaces are spaced apart and spread along a height direction of the first side wall, the load-bearing device comprises an insertion portion, and the insertion portion is configured to be inserted into the interfaces to achieve a detachable connection between the load-bearing device and the sliding member.

5. The handling truck according to claim 4, wherein the mast assembly further comprises a handle, wherein the handle is disposed on a side wall of the fixed member distal to the first opening.

6. The handling truck according to claim 5, wherein the fixed member comprises a main body portion and two flange portions, wherein the two flange portions are respectively disposed on two sides of the main body portion, each of the two flange portions defines an auxiliary channel, a part of the main channel is located inside the main body portion, another part of the main channel communicates with the auxiliary channels, and the auxiliary channels extend along a length direction of the main channel.

7. The handling truck according to claim 6, wherein the mast assembly further comprises at least two bearings, wherein the two bearings are respectively disposed on two opposite side walls of the sliding member, and each of the bearings is disposed in a corresponding one of the auxiliary channels to thereby attach the sliding member to the fixed member.

8. The handling truck according to claim 7, wherein the mast assembly further comprises a buffer member, wherein the buffer member covers an outer ring of each bearing.

9. The handling truck according to claim 8, wherein the leg assembly comprises a first leg, a second leg, a first wheel, and a second wheel, wherein the first leg and the second leg are connected to each other, the first wheel is rotatably disposed at a bottom of the first leg, the second wheel is rotatably disposed at an end of the second leg, and an end of the connecting portion is disposed at a connection point between the first leg and the second leg.

10. The handling truck according to claim 9, wherein the driving member comprises a hydraulic cylinder and a foot pedal assembly, wherein the hydraulic cylinder comprises a housing composed of a base seat and an outer cylinder barrel, a valve body is fixedly installed inside the housing, an inner cylinder barrel located inside the outer cylinder barrel is fixedly installed at an upper end of the valve body, an oil storage cavity is formed between the outer cylinder barrel, the inner cylinder barrel, and the valve body, a piston rod is slidably disposed in the inner cylinder barrel, a pressure cavity is defined by the piston rod, the inner cylinder barrel, and the valve body, a lower piston is vertically disposed in the base seat in a slidable manner, the lower piston is located below the valve body and is driven to move upward by the foot pedal assembly, a joint is provided below the valve body, an inner piston is slidably disposed in the joint, a first pressurizing cavity is defined by the lower piston, the valve body, the joint, and the base seat, a second pressurizing cavity is defined by the inner piston, the joint, and the valve body, a first oil passage is provided between the first pressurizing cavity and the second pressurizing cavity, and the first pressurizing cavity communicates with the second pressurizing cavity via the first oil passage, the valve body is internally provided with a second oil passage connecting the oil storage cavity and the first pressurizing cavity, an oil inlet passage connecting the second pressurizing cavity and the pressure cavity, and an oil return passage connecting the second pressurizing cavity and the oil storage cavity, an oil passage one-way valve is provided in the first oil passage, an oil passage valve is provided in the second oil passage, an oil inlet valve is provided in the oil inlet passage, an oil return one-way valve is provided in the oil return passage, when the piston rod needs to move upward, the foot pedal assembly drives the lower piston to move upward to compress the first pressurizing cavity, the oil pressure in the first pressurizing cavity causes the oil passage valve to block the second oil passage and the oil passage one-way valve to open the first oil passage, hydraulic oil in the first pressurizing cavity enters the second pressurizing cavity through the first oil passage, the upward movement of the lower piston drives the inner piston to move upward to compress the second pressurizing cavity, the oil pressure in the second pressurizing cavity causes the oil inlet valve to open the oil inlet passage, and hydraulic oil in the second pressurizing cavity enters the pressure cavity through the oil inlet passage; when the piston rod needs to move downward, the foot pedal assembly drives the lower piston to move upward until the inner piston pushes the oil inlet valve to open the oil inlet passage, the oil return one-way valve opens the oil return passage, and hydraulic oil in the pressure cavity returns to the oil storage cavity through the oil inlet passage, the second pressurizing cavity, and the oil return passage.

11. The handling truck according to claim 10, wherein the valve body is internally provided with a valve core bore, a side wall of the valve core bore is provided with an oil inlet hole and an oil outlet hole that communicate with the oil return passage and are oppositely disposed, an adjusting valve core is slidably disposed in the valve core bore along an axial direction, the valve core bore at a side of the adjusting valve core communicates with the oil storage cavity, the valve core bore at another side communicates with the oil inlet passage, the adjusting valve core includes a frustum segment disposed opposite to the oil inlet hole, and the diameter of the frustum segment gradually increases from a side of the valve core bore communicating with the oil storage cavity to another side.

12. The handling truck according to claim 11, wherein a first spring is provided in the valve core bore to provide elastic force to move the adjusting valve core toward a side where the oil inlet passage is located, the adjusting valve core further comprises a first cylindrical segment with a diameter equal to a minimum diameter of the frustum segment and a second cylindrical segment with a diameter equal to a maximum diameter of the frustum segment, the first cylindrical segment is connected to the frustum segment at a position with the minimum diameter, the second cylindrical segment is connected to the the frustum segment at a position with the maximum diameter, the adjusting valve core is provided with a first protruding ring and a second protruding ring that abut and seal against the side wall of the valve core bore, the first protruding ring is located on a side of the first cylindrical segment distal to the frustum segment, and the second protruding ring is located on a side of the second cylindrical segment distal to the frustum segment.

13. The handling truck according to claim 12, wherein the oil passage valve comprises an oil passage valve core for blocking and opening the second oil passage and a second spring that provides elastic force to return the oil passage valve core toward a side where the oil storage cavity is located, the valve body is internally provided with an installation hole, a pressure-reducing valve core is slidably disposed in the installation hole, the installation hole at a side of the pressure-reducing valve core communicates with the pressure cavity, and an end of the pressure-reducing valve core distal to the pressure cavity is connected to the oil passage valve core, during heavy loads, the pressure-reducing valve core pushes the oil passage valve core to open the second oil passage.

14. The handling truck according to claim 13, wherein the valve body is provided with an installation sleeve, a pushing shaft is slidably disposed in the installation sleeve, the pushing shaft is located between the pressure-reducing valve core and the oil passage valve core, and a third spring is sleeved over the pushing shaft, the third spring provides elastic force to move the pushing shaft toward a side where the pressure-reducing valve core is located.

15. The handling truck according to claim 14, wherein the oil passage valve core is internally provided with an oil discharge passage, and the oil storage cavity communicates with the first pressurizing cavity via the oil discharge passage.

16. The handling truck according to claim 15, wherein the oil inlet valve comprises an oil inlet valve core for blocking and opening the oil inlet passage and a fourth spring that provides elastic force to return the oil inlet valve core toward a side where the second pressurizing cavity is located, with an end of the oil inlet valve core proximal to the second pressurizing cavity extending out of the valve body; the oil return one-way valve comprises an oil return valve core for blocking and opening the oil return passage and a fifth spring that provides elastic force to return the oil return valve core toward a side where the second pressurizing cavity is located, with an end of the oil return valve core proximal to the second pressurizing cavity extending out of the valve body; the elastic force of the fourth spring is significantly less than that of the fifth spring; when the inner piston moves upward and pushes the oil inlet valve core and the oil return valve core to move into the valve body, the oil inlet valve core opens the oil inlet passage, and the oil return valve core opens the oil return passage.

17. The handling truck according to claim 16, wherein the lower piston is cylindrical with an opening facing upward and a hollow interior, an installation seat is provided inside the lower piston, the installation seat comprises a bottom plate and a sleeve portion located above the bottom plate, a recess is formed by concaving an inner end face of the lower piston, the bottom plate is provided with an oil passage hole, the first pressurizing cavity communicates with the recess via the oil passage hole, an upper end of the sleeve portion is fixedly connected to a lower end of the inner piston, and the upper end of the sleeve portion is received inside the inner piston, the installation seat is internally provided with a through hole, the recess communicates with the second pressurizing cavity via the through hole, the oil passage hole, the recess, and the through hole collectively form the first oil passage, the oil passage one-way valve is disposed in the through hole, a sixth spring is sleeved over the sleeve portion and the sixth spring is located between the inner piston and the bottom plate, when the inner piston pushes the oil inlet valve and the oil return one-way valve, a lower end of the joint 139 abuts the sixth spring.

18. The handling truck according to claim 17, wherein a seventh spring is sleeved over the joint, with an upper end of the seventh spring abutting the valve body and a lower end of the seventh spring abutting the bottom plate.

19. The handling truck according to claim 18, wherein the foot pedal assembly comprises a base frame installed below the base seat, a first hinge seat with a lower end hinged to the base frame, a second hinge seat, and a foot pedal, wherein an upper end of the first hinge seat is hinged to the second hinge seat, a first end of the second hinge seat is hinged to the lower piston, and a second end of the second hinge seat is hinged to an end of the foot pedal, a torsion spring is mounted on a hinge shaft between the second hinge seat and the foot pedal, configured to provide elastic force to bias the foot pedal toward upward rotation, and an end portion of the foot pedal hinged to the second hinge seat is provided with a limit plate that abuts and limits the second hinge seat.
